(19) United States
(12) Patent Application Publication
(10) Pub. No.: US 2011/0090846 A1
(43) Pub. Date: Apr. 21, 2011

(54) Portable Access Point

(75) Inventors: Thomas Hao, Toronto (CA); Tom Papadopoulos, North York (CA); Florin Tarcoci, Mississauga (CA); Rodney D. Gilchrist, Oakville (CA); John K. Stevens, Stratham, NH (US); Christopher W. Verge, Hamilton (CA); Paul Waterhouse, Selkirk (CA); M. Jason August, Toronto (CA)

(73) Assignee: Visible Assets, Inc., Mississauga (CA)

(21) Appl. No.: 12/785,154

(22) Filed: May 21, 2010

Related U.S. Application Data
(63) Continuation-in-part of application No. 12/429,835, filed on Apr. 24, 2009.
Application No. 12/429,835 is a continuation-in-part of application No. 12/108,877, filed on Apr. 24, 2008.
(60) Provisional application No. 61/180,345, filed on May 21, 2009.

(51) Int. Cl. H04W 88/08

(52) U.S. Cl. 370/328

(57) ABSTRACT

A portable access point device is formed from a handheld computing device; an environmentally hardened case disposed around the computing device, and an access point module for reading and writing data to low frequency active radiating transceiver tags, such as RuBee® tags. The access point module is connected to the handheld computing device and the environmentally hardened case to provide a unitary handheld device, and the access point module transfers data between the handheld computing device and tags within communication range of the device.

### STATEMENT OF RELATED CASES

This application claims the benefit of U.S. Provisional Application No. 61/180,345, filed May 21, 2009, which application is incorporated herein by reference in its entirety.

This application is a continuation-in-part of U.S. patent application Ser. No. 12/429,835 filed Apr. 24, 2009, which application is incorporated herein by reference in its entirety.

This application is a continuation-in-part of U.S. patent application Ser. No. 12/108,877 filed Apr. 24, 2008, which application is incorporated herein by reference in its entirety.

### BACKGROUND OF THE INVENTION

The present invention relates to a portable access point, and to its use in accessing electronic tags in a field environment. The portable access point of the present invention is particularly useful with a low frequency active radiating transceiver tag such as a RuBee® tag.

The use of electronic tags to monitor articles, animals and even people if becoming increasingly common. Radio tags communicate via magnetic (inductive communication) or electric radio communication to a base station or reader, or to another radio tag. A RuBee® radio tag works through water and other bodily fluids, and near steel, with an eight to fifteen foot range, a five to ten-year battery life, and three million reads/writes. It operates at 132 Khz and is a full on-demand peer-to-peer, radiating transceiver.

RuBee® is a bidirectional, on-demand, peer-to-peer transceiver protocol operating at wavelengths below 450 Khz (low frequency). A transceiver is a radiating radio tag that actively receives digital data and actively transmits data by providing power to an antenna. A transceiver may be active or passive. The RuBee® standard is documented in the IEEE Standards body as IEEE P1902.1™.

Low frequency (LF), active radiating transceiver tags are especially useful for visibility and for tracking both inanimate and animate objects with large area loop antennas over other more expensive active radiating transponder high frequency (HF)/ultra high frequency (UHF) tags. These LF tags function well in harsh environments, near water and steel, and may have full two-way digital communications protocol, digital static memory and optional processing ability, sensors with memory, and ranges of up to 100 feet. The active radiating transceiver tags can be far less costly than other active transceiver tags (many under one dollar), and often less costly than passive back-scattered transponder RFID tags, especially those that require memory and make use of EEPROM. With an optional on-board crystal, these low frequency radiating transceiver tags also provide a high level of security by providing a date-time stamp, making full AES (Advanced Encryption Standard) encryption and one-time pad ciphers possible.

One of the advantages of the RuBee® tags is that they can transmit well through water and near steel. This is because RuBee® operates at a low frequency. Low frequency radio tags are immune to nulls often found near steel and liquids, as in high frequency and ultra high-frequency tags. This makes them ideally suited for use with tools made of steel and/or tools stored near steel shelving. Fluids have also posed significant problems for current tags. The RuBee® tag works well through water. In fact, tests have shown that the RuBee® tags work well even when fully submerged in water. This is not true for any frequency above 1 MHz. Radio signals in the 13.56 MHz range have losses of over 50% in signal strength as a result of water, and anything over 30 MHz have losses of 99%.

Another advantage is that RuBee® tags can be networked. One tag is operable to send and receive radio signals from another tag within the network or to a reader. The reader itself is operable to receive signals from all of the tags within the network. These networks operate at long-wavelengths and accommodate low-cost radio tags at ranges to 100 feet. The standard, IEEE P1902.1™, “RuBee Standard for Long Wavelength Network Protocol”, will allow for networks encompassing thousands of radio tags operating below 450 kHz.

The inductive mode of the RuBee® tag uses low frequencies, 3-30 kHz VLF or the Myriametric frequency range, 30-300 kHz LF in the Kilometric range, with some in the 300-3000 kHz MF or Hectometric range (usually under 450 kHz). In some embodiments, the tag operates at a frequency of 132 kHz. Since the wavelength is so long at these low frequencies, over 99% of the radiated energy is magnetic, as opposed to a radiated electric field. Because most of the energy is magnetic, antennas are significantly (10 to 1000 times) smaller than ¼ wavelength or 1/10 wavelength, which would be required to efficiently radiate an electrical field. This is the preferred mode.

As opposed to the inductive radiation mode above, the electromagnetic mode uses frequencies above 3000 kHz in the Hectometric range, typically 8-900 MHz, where the majority of the radiated energy generated or detected may come from the electric field, and a ¼ or 1/10 wavelength antenna or design is often possible and utilized. The majority of radiated and detected energy is an electric field.

RuBee® tags are also programmable, unlike conventional RFID tags. The RuBee® tags may be programmed with additional data and processing capabilities to allow them to respond to sensor-detected events and to other tags within a network.

### SUMMARY OF THE INVENTION

The present invention provides a portable access point device comprising:

(a) a handheld computing device;

(b) an environmentally hardened case disposed around the computing device, and

(c) an access point module for reading and writing data to low frequency active radiating transceiver tags, such as RuBee® tags. The access point module is connected to the handheld computing device and the environmentally hardened case to provide a unitary handheld device, and the access point module transfers data between the handheld computing device and tags within communication range of the device.

The invention further provides systems that include at least one portable access point device and at least one piece of equipment to be monitored that has a low frequency active radiating transceiver tags, such as a RuBee® tag affixed to it. In some embodiments, the equipment may be tools, while in other embodiments the equipment is weapons.

### BRIEF DESCRIPTION OF THE DRAWINGS

FIG. 1 shows a handheld computing device useful in the portable access point in accordance with the present invention.

FIGS. 2A and 2B show a portable access point in accordance with the present invention.

FIGS. 3A-3C show additional details of a portable access point in accordance with the invention.

FIG. 4 shows an embodiment of the portable access point in accordance with the invention.

FIGS. 5A and 5B show the portable access point in accordance of the invention when used with a wireless recharger and data transfer module.

FIG. 6 shows a smart case designed to automatically detect tool presence or absence within the case.

FIGS. 7A and 7B show a portable access point in accordance with the invention in use for monitoring of weapons.

### DETAILED DESCRIPTION OF THE INVENTION

The present invention relates to a portable access point device.

As used in this application, the term “portable” refers to a device that can be held by a person of ordinary strength in one or two hands, without the need for any special carriers, while walking and performing tasks using the access point device for data retrieval and input.

The term “access point” has its ordinary meaning in the data communications art, namely, the device functions as a specially configured node of a wireless local area networks that acts as a central transmitter and receiver of signals from tags within range of the device.

The portable access point device of the invention comprises a hand held computing device. This may be an off-the-shelf device such as an Apple i-TOUCH or may be a purpose built computing device.

The portable access point device of the invention also comprises an environmentally-hardened case disposed around the computing device. As used in this application, the term “environmentally-hardened” means that the case provides protection to the computing device against one or more environmental hazards with which the device may come in contact in the course of its intended use. Such environmental hazards include shock (for example if dropped), chemical fumes, water, dirt, dust and the like. The environmentally-hardened case also provides a connection point for the handheld computing device so that the connection is also protected. For example, the case may provide a thirty pin connector for connection to the access point module discussed below, as well as a waterproof USB connector for data transfer or device charging.

The third component of device of the invention is an access point module which is attachable to the environmentally hardened case in such a manner that it is connected for communication with the hand-held computing device in an environmentally-protected way to provide a unitary portable device. As used in this application, the term “unitary” means that the device is held together as a single structure in ordinary use (i.e. not parts connected by hanging wires), but not means that it cannot be purposefully separated into component parts, for example using tools such as a screwdriver.

The access point module contains electronic hardware that can perform a variety of functions, but that at a minimum provides for reading and writing data to low frequency active radiating transceiver tags within communication range of the device. For example, the access point module may contain a RuBee® reader for communication with RuBee® tags. This reader/writer functionality is provided by an antenna, for example a loop antenna, having a size consistent with the desired range of the reader and a microcontroller for directing the content of messages sent to low frequency active radiating transceiver tags within communication range of the device, and for processing messages received from the tags.

In addition to the tag reader functionality, the access point module may also provide one or more other functions for transferring information to or from the hand-held computing device. For example, the access point module may include a barcode reader (for example for reading 1D and 2D barcodes using a laser scanner), a smart card reader (for example suitable for reading military ID cards), a wireless data link, and/or a charging system (for example one part of an inductive wireless recharger that recharges the access point module when placed on a suitable pad).

The portable access point of the present invention is useful in field applications with a variety of different types of articles equipped with low frequency active radiating transceiver tags such as RuBee® tags. Such articles include tools (See commonly assigned U.S. Patent Publication No. 2009/0267769), medical and surgical equipment including implanted devices (See commonly assigned U.S. Patent Publications Nos. 2008/0319280 and 20080246610), and firearms (see commonly assigned PCT Application No. WO/2008/134443).

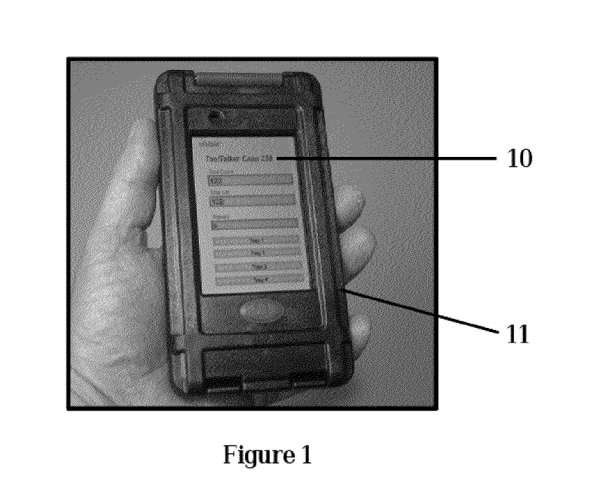

FIG. 1 shows handheld computing device useful in the portable access point in accordance with the present invention. The handheld device as depicted is an Apple iTouch™ 10 with environmentally hardened case 11. The handheld computing device meets MIL-STD-810G, UL 913-88 and ATEX standards for use in harsh environment applications. The handheld computing device is enabled to read and write tags in compliance with the IEEE 1902.1 protocol and can be used to commission tags, such as RuBee® tags, and to read and confirm status of items such as mission critical tools kits or small arms.

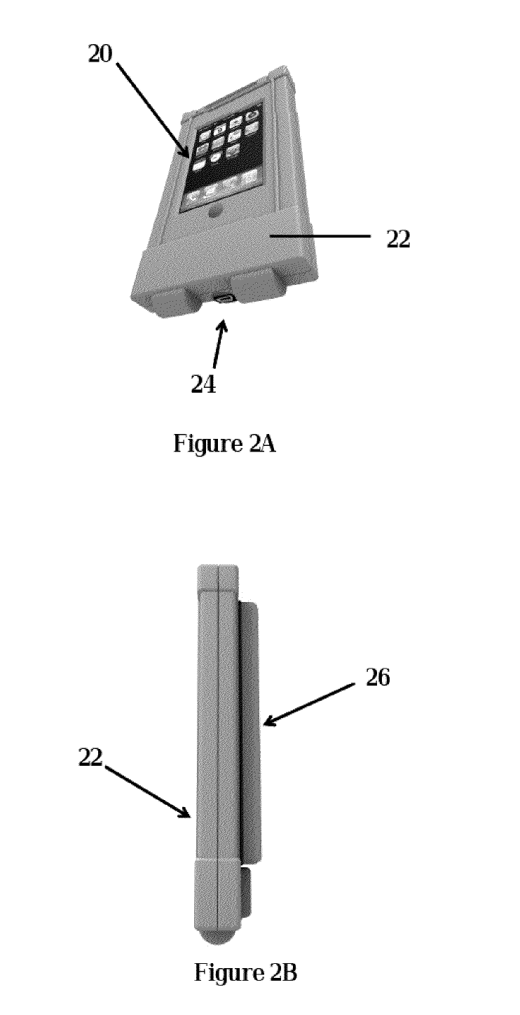

FIGS. 2A and 2B show a portable access point in accordance with the present invention. An environmentally hardened case 22 is disposed around the computing device 20 which may be visible through a 10 mil polycarbonate window to provide greater protection. An external connector, such as a USB mini connector 24 may be provided accessible through the environmentally hardened case 22. Additional communication functionality including an antenna for communication with tags is provided through access point module 26 for reading and writing data to low frequency active radiating transceiver tags.

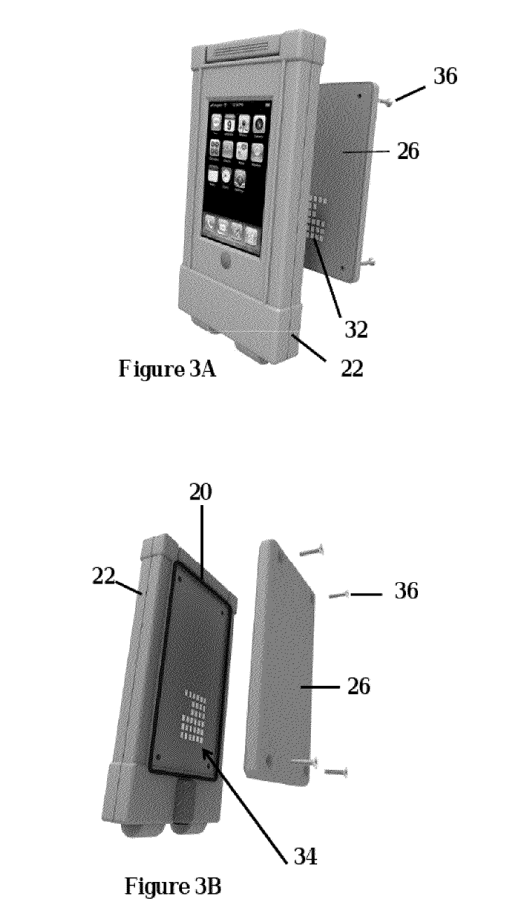

FIGS. 3A-3C shows additional details of a portable access point in accordance with the invention in which the access point module 26 is shown adjacent to the environmentally hardened case 22. The access point module 26 has a connector 32, such as 30 pin connector, that connects directly to a corresponding connector 34 on the handheld computing device 20, or indirectly via a passthrough connector on the environmentally hardened case. Screws 36 or other fasteners can be used to secure the access point module to the handheld computing device and environmentally hardened case as shown in FIG. 3C.

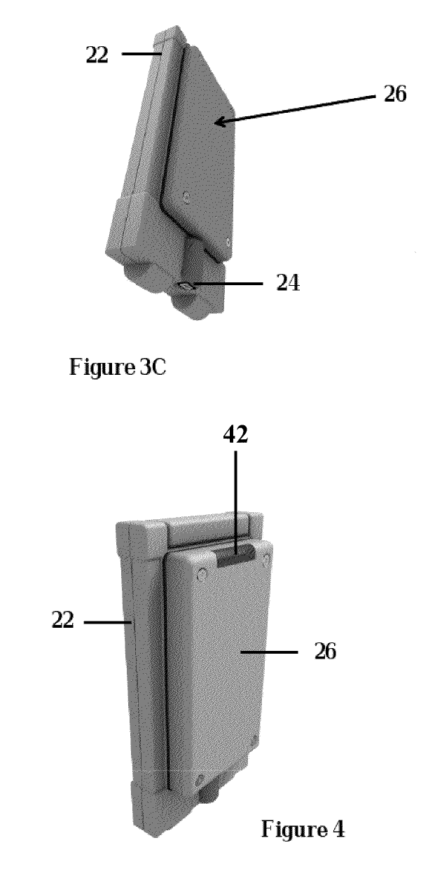

FIG. 4 shows an embodiment of the invention in which the access point module 26 is equipped with a bar code reader 42.

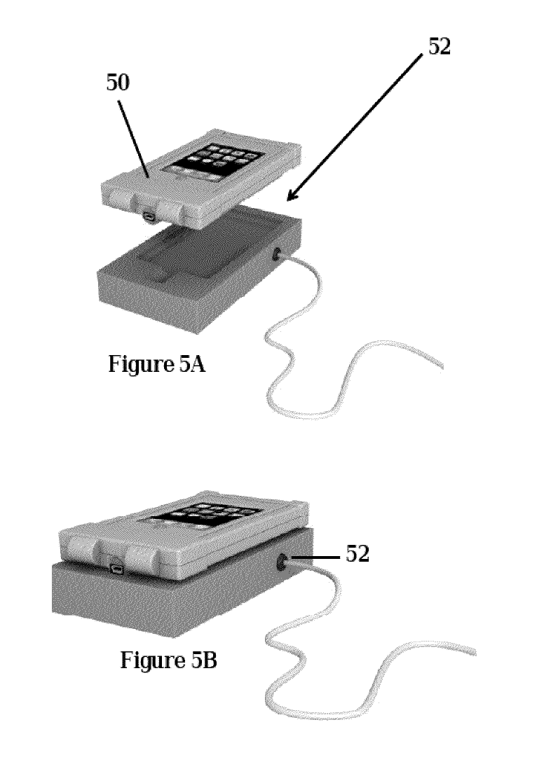

FIGS. 5A and 5B show the portable access point 50 of the invention in combination with a wireless recharger pad 52. The wireless recharger pad is an inductive wireless recharger which uses the low frequency antenna in the access point module to recharge the batteries of the handheld computing device. For example, the batteries of an Apple iTouch™ can be recharged in a period of about 6 hours. In addition, the wireless recharger pad 52 may contain a high speed data link for secure transfer of information from the portable access point 50 as described in U.S. Pat. No. 7,321,290. Using a wireless recharger pad with data transfer capability allows the external connector (24 in FIG. 2A) to be omitted which can enhance the environmental resistance of the portable access point.

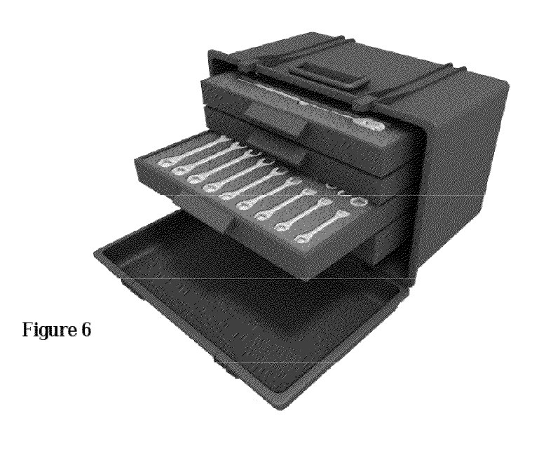

FIG. 6 shows a smart case designed to automatically detect tool presence or absence within the case. The portable access point of the present invention can be used to provide an indication that all tools are present or not present, or can provide detailed information about tool status. This can be used to ensure that all needed tools are taken on missions, or that all tools have been recovered after use. The latter is desirable to prevent foreign object destruction, for example in aerospace applications.

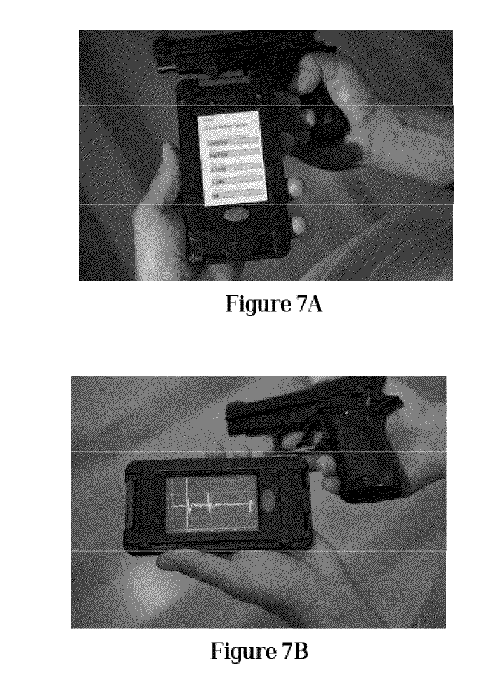

FIGS. 7A and B show a portable access point in accordance with the invention in use for monitoring of weapons, for example in an armory. The portable access device can be used to provide a read out of the identification or a weapon, as well as the number of shots fired and when the shots were fired (FIG. 7A). The portable access device can also be used to provide an advanced waveform analysis of a weapon (FIG. 7B). These systems provide enhanced safety and the ability provide the highest possible mission critical performance.

Each of the patents, patent applications and published documents cited herein is incorporated herein by reference in its entirety.

1. A portable access point device comprising:
(a) a handheld computing device;
(b) an environmentally hardened case disposed around the computing device, and
(c) an access point module for reading and writing data to low frequency active radiating transceiver tags, wherein the access point module is connected to the handheld computing device and the environmentally hardened case to provide a unitary handheld device, and the access point module transfers data between the handheld computing device and tags within communication range of the device.

2. The device of claim 1, wherein the handheld computing device has a display that is visible when the computing device is disposed in the environmentally hardened case, and wherein data transferred from tags within communication range of the device is presented to a user on the display.

3. The device of claim 2, wherein the display is a touch screen display.

4. The device of claim 3, wherein the access point module comprises a tag reader for transferring data between the device and tags within communication range of the device.

5. The device of claim 4, wherein the access point further comprises a barcode reader.

6. The device of claim 4, wherein the access point further comprises a smart card reader.

7. The device of claim 4, wherein the access point further comprises a wireless datalink.

8. A system for monitoring of tools comprising
at least one portable access point device comprising:
(a) a handheld computing device;
(b) an environmentally hardened case disposed around the computing device, and
(c) an access point module for reading and writing data to low frequency active radiating transceiver tags, wherein the access point module is connected to the handheld computing device and the environmentally hardened case to provide a unitary handheld device, and the access point module transfers data between the handheld computing device and tags within communication range of the device, and
at least one tool having a low frequency active radiating transceiver tag affixed thereto.

9. A system for monitoring of tools comprising
at least one portable access point device comprising:
(a) a handheld computing device;
(b) an environmentally hardened case disposed around the computing device, and
(c) an access point module for reading and writing data to low frequency active radiating transceiver tags, wherein the access point module is connected to the handheld computing device and the environmentally hardened case to provide a unitary handheld device, and the access point module transfers data between the handheld computing device and tags within communication range of the device, and
at least one tool storage unit having a low frequency active radiating transceiver tag affixed thereto to indicate the placement of the correct tool(s) within the tool storage unit.

10. A system for monitoring of weapons comprising
at least one portable access point device comprising:
(a) a handheld computing device;
(b) an environmentally hardened case disposed around the computing device, and
(c) an access point module for reading and writing data to low frequency active radiating transceiver tags, wherein the access point module is connected to the handheld computing device and the environmentally hardened case to provide a unitary handheld device, and the access point module transfers data between the handheld computing device and tags within communication range of the device, and
at least one weapon having a low frequency active radiating transceiver tag affixed thereto.
